(19) United States
(12) Patent Application Publication
(10) Pub. No.: US 2014/0099238 A1
(43) Pub. Date: Apr. 10, 2014

(54) Chiral Separation System

(71) Applicant: Waters Technologies Corporation, Milford, MA (US)

(72) Inventor: Siqun Huang, Westborough, MA (US)

(21) Appl. No.: 14/048,449

(22) Filed: Oct. 8, 2013

Related U.S. Application Data
(60) Provisional application No. 61/710,870, filed on Oct. 8, 2012.

(51) Int. Cl. C07B 57/00

(52) U.S. Cl. CPC C07B 57/00
USPC 422/105; 422/261

(57) ABSTRACT

A system for separation of enantiomers includes a column packed with a stationary phase; a magnetic field generator generating a magnetic field, within which the column is placed, and the magnetic field interacts with the enantiomers as the enantiomers elute through the column with a mobile phase; and a control unit, in communication with the magnetic field generator and the column, to adjust the strength and direction of the magnetic field to separate the enantiomers.

### BACKGROUND INFORMATION

A chiral compound is composed of molecules that do not possess any symmetric element and exist in two forms that are non-superimposable mirror images of each other. The two forms are commonly referred to as “right-” and “left-handed enantiomers” or “enantiomers” for short. Chirality is a subject of considerable interest in the pharmaceutical industry, as most of drugs are chiral or preferably to be made chiral in order to effectively interact with an enzyme or a receptor surface where a disease arises. Usually, only one enantiomer of a pair is active in reacting with the enzyme or receptor surface. The active enantiomer is often referred to as a eutomer and the inactive one as a distomer. The distomer is not only inactive but also antagonistic to the biological activities of the eutomer or even toxic. Because of the adverse effects of the distomer, chiral separation—separation of one enantiomer (eutomer) from the other (distomer)—is essential in the production and development of chiral drugs.

To separate enantiomers, one has to utilize at least one of their properties that can distinguish them from each other. Two enantiomers, however, display virtually identical chemical and physical properties and only distinguished by two properties. One property is their chemical response to other chiral compounds. That is, two enantiomers exhibit different affinities in interacting with a same chiral compound. This property is utilized by almost all existing chiral separation techniques, including liquid chromatography (LC), capillary electrophoresis, biosensors, membranes, crystallization, biotransformation, etc.

All these techniques, unfortunately, depend, more or less, on a chiral selector that has higher affinity to one enantiomer than to the other, requiring an analyte-specific chiral selector to do the separation. In other words, an analyte-specific chiral selector must be synthesized in order to produce a single-enantiomer drug, with an associated cost.

The other property that can differentiate enantiomers is their optical activity in respect of plane-polarized light. That is, both enantiomers rotate plane-polarized light; the right-handed (D-) enantiomer rotates the light clockwise, whereas the left-handed (L-) enantiomer rotates the light counterclockwise. Because of their optical activity, enantiomers are also referred to as optical isomers.

### SUMMARY

Some embodiments arise, in part, from the realization that a system can advantageously be configured to separate enantiomers, based on the optical activity that is unique to each of the enantiomers. Such systems separate enantiomers without the need for a chiral selector and can be applied universally to all chiral separations.

One embodiment features a system for separation of enantiomers, which includes a column, a magnetic field generator and a control unit. The column is packed with a stationary phase. The magnetic field generator produces a magnetic field, within which the column is placed, and the magnetic field interacts with the enantiomers as the enantiomers elute through the column with a mobile phase. The control unit is in communication with the magnetic field generator and the column to adjust the strength and direction of the magnetic field to separate the enantiomers.

Another embodiment characterizes a system for separation of enantiomers, which includes a column, at least one light source and a control unit. The column is packed with a stationary phase. The at least one light sources produces at least one plane-polarized light beam that is directed to the column to interact with the enantiomers as the enantiomers elute through the column with a mobile phase. The control unit is in communication with the light source and the column to adjust the intensity and direction of the at least one plane-polarized light beam to separate the enantiomers.

Implementations may include one or more of the following features.

In some implementations, the magnetic field generator includes at least one solenoid, at least one permanent magnet, a superconducting magnet, or any other suitable magnetic field generator.

In some implementations, the magnetic field is a static magnetic field.

In some implementations, the strength of the magnetic field is adjusted to induce a magnetic moment in each of the enantiomers and to align the induced magnetic moment with the magnetic field.

In some cases, the direction of the magnetic field is adjusted by varying an angle or a distance, or both thereof, between the magnetic filed and the column.

In some implementations, the stationary phase includes a ferromagnetic material, e.g., Fe₃O₄ nanocrystals having a size of smaller than 1000 nm.

In some implementations, the column can be a C18, monolithic, ion exchange, hydrophilic, hydrophobic, or any other suitable liquid chromatography column.

In some implementations, the column is encased in a non-magnetic material, such as polyetheretherketone or stainless steel.

In some implementations, one or both of the mobile phase and the stationary phase contains a chiral selector, which includes cyclodextrins or cyclodextrin derivatives.

In some implementations, the system further includes a temperature regulator including one or more temperature sensors and one or more cooling elements to regulate the temperature of the column.

In some implementations, the one or more temperature sensors are operatively coupled to the column to sense a rise in the temperature thereof and send one or more temperature signals to the control unit, and the control unit, in signal communication with the one or more temperature sensors, controls the operation of the one or more cooling elements, in response to the one or more temperature signals.

In some implementations, the light source includes a natural light source coupled with a polarizer. In other implementations, the light source includes a laser source, which is a pulsed laser source or a continuous-wave laser source.

In some implementations, the intensity of the at least one plane-polarized light beam is adjusted to induce a magnetic moment in each of the enantiomers and to align the induced magnetic moment with the magnetic field component of the at least one plane-polarized light beam.

In some implementations, the light source includes light intensity control circuitry to control the intensity of the at least one plane-polarized light beam.

In some implementations, the intensity of the at least one plane-polarized light beam is adjusted by varying the photon density of the at least one plane-polarized light beam.

In other implementations, the intensity of the at least one plane-polarized light beam is adjusted by varying the number of the at least one plane-polarized light beam.

In some implementations, the column and the stationary phase include a transparent material, which is optically inactive over a working wavelength range of the at least one light source. In some implementations, the working wavelength range is from infrared wavelengths to visible wavelengths.

Other implementations, features and advantages are in the description, drawings and claims.

### BRIEF DESCRIPTION OF THE DRAWINGS

In the drawings, same or like reference characters and numbers generally refer to same or like elements throughout different views. Also, the drawings are not necessarily to scale.

FIGS. 1A-1D are schematic views of two enantiomers under the influence of a magnetic field.

FIG. 2 is a schematic view of a system for separation of enantiomers, including a LC column, a magnetic field generator and a control unit.

FIGS. 3A-3C are schematic views of three types of magnetic field generators applied to a LC column.

FIG. 4 is a schematic view of a plane-polarized light beam interacting with a solution of single enantiomers.

FIG. 5 is a schematic view of a system for separation of enantiomers, including a sample cell, a light source and a control unit.

### DETAILED DESCRIPTION

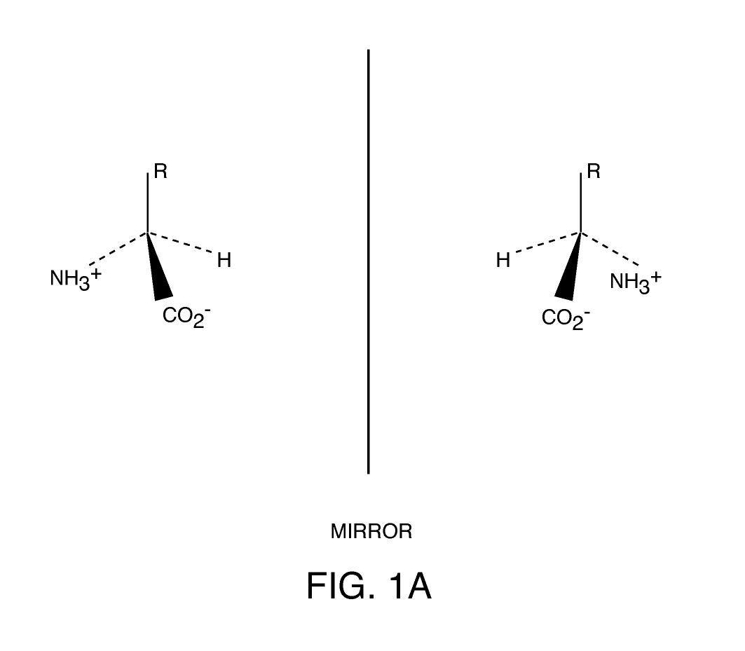

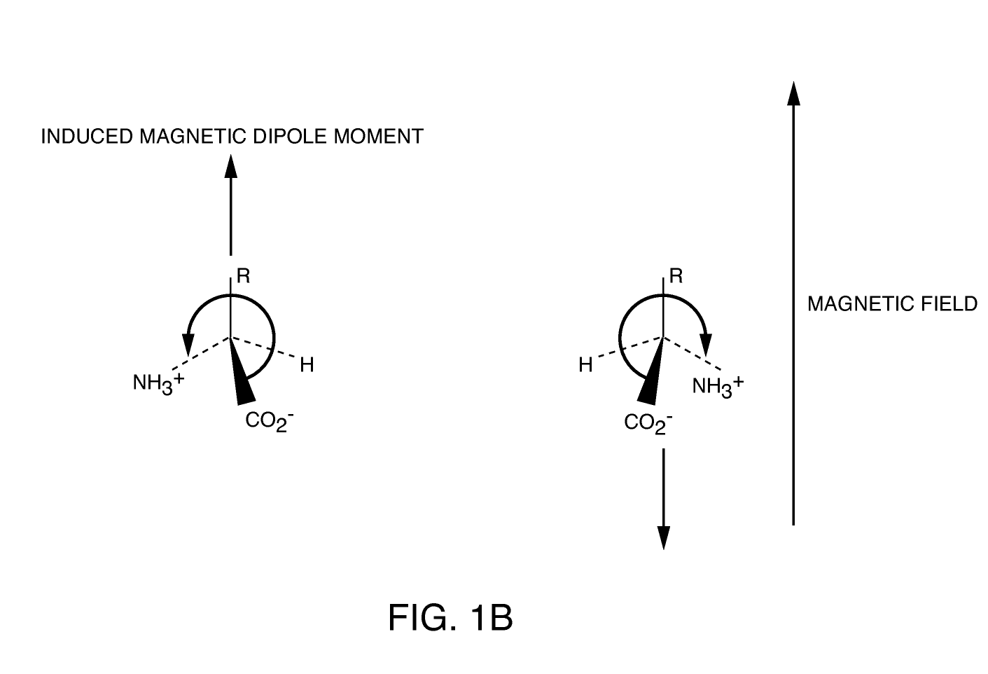

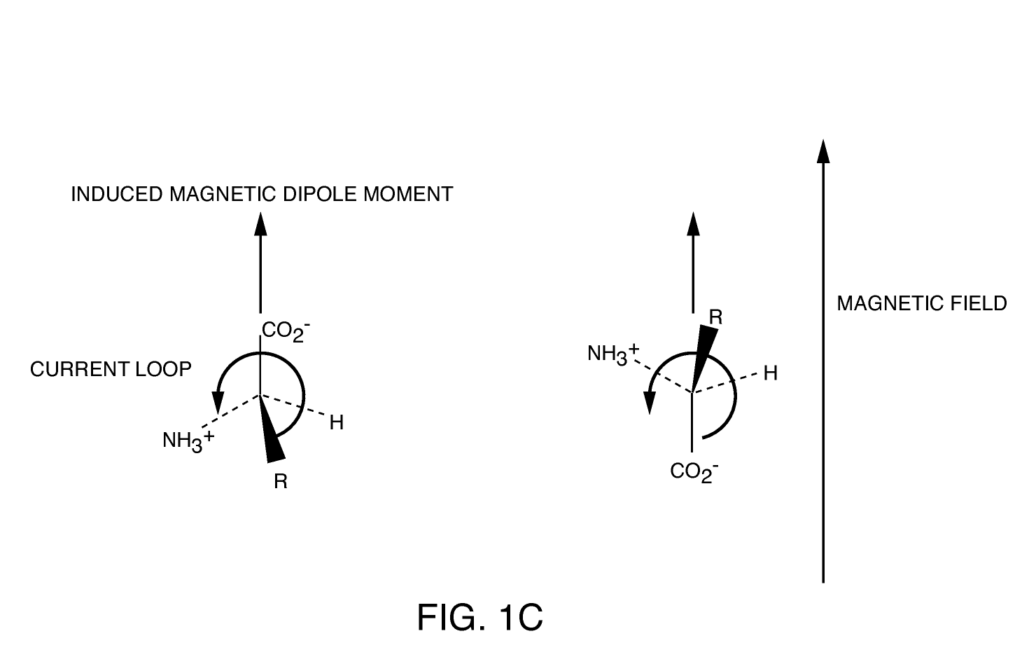

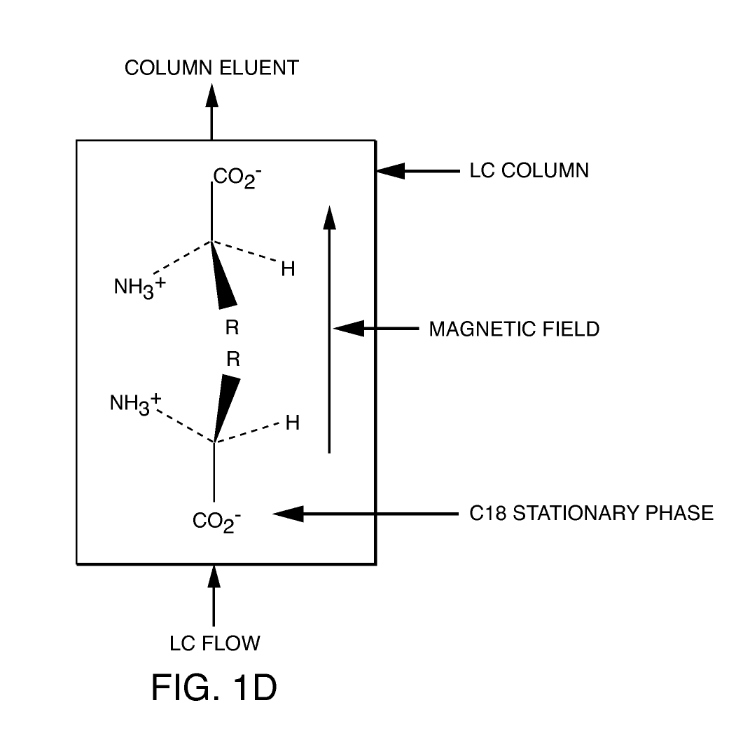

Some illustrative implementations will now be described with respect to FIGS. 1-5. In view of this description, modifications and alterations to these implementations will be apparent to one of ordinary skill in the art.

As presented above, the only physical property that is unique to each of enantiomers is their optical activity in respect of plane-polarized light, i.e., both enantiomers rotate plane-polarized light; the right-handed (D-) enantiomer rotates the light clockwise, whereas the left-handed (L-) enantiomer rotates the light counterclockwise. Plane-polarized light, as known in the art, is composed of electromagnetic waves oscillating in a single plane, or, in other words, it is composed of electric field component oscillating in one direction and magnetic field component oscillating perpendicularly to the electric waves. From this well known physical phenomenon, the following logical corollary can be drawn.

When a magnetic field of a fixed direction and magnitude is exerted on a solution of enantiomers, the magnetic field will induce a current loop within the nuclear framework of each enantiomeric molecule, and thereby induce an intrinsic magnetic field and a magnetic dipole thereof. The direction of the induced magnetic dipole of each enantiomer is determined by the orientation of the enantiomer and obeys the right hand rule—the thumb points to the direction of the induced magnetic dipole when the fingers of the right hand curl in the direction of the induced current loop of the enantiomer. If the magnetic field is weak, the induced magnetic dipoles will distribute in a random and unpredictable fashion due to their thermal motions, and for each enantiomer pair, their induced magnetic dipoles will point to opposite directions, based on the right hand rule. However, if the magnetic field is sufficiently strong, the induced magnetic dipoles will tend to line up in the direction of the applied field, i.e., all the induced magnetic dipoles will point to the same direction as that of the applied field. To make such alignment happen, the geometrical bodies of enantiomers need to be rearranged or reoriented in space, e.g., one enantiomer of a pair must flip upside down to have its induced magnetic dipole lined up with that of the other in the pair. As a result, the thermal motions become negligible and the induced magnetic dipoles will distribute in a predictable manner.

In the context of LC separation, as the reoriented enantiomers elute through a LC column that is placed in the magnetic field and packed with a stationary phase, the two enantiomers become distinguishable in respect of the stationary phase. The two enantiomers will interact with the stationary phase differently, have different retention times in the column, and be eventually separated from each other. The influence of a magnetic field on enantiomers is illustrated in FIGS. 1A-1D.

FIG. 1A is an example of a pair of enantiomeric molecules, an amino acid having the structural formula RCH(NH₃⁺)CO₂⁻. Each of the pair has a carbon (or chiral center) covalently connected to four different groups: hydrogen, carboxyl, amine, and alkyl groups.

When the two enantiomers are placed in a magnetic field, the magnetic field induces a current loop within the nuclear framework of each enantiomeric molecule. The induced current loops are also mirror images of each other, as shown in FIG. 1B. Each of the induced current loops gives rise to its own magnetic field and a magnetic dipole thereof, and the direction of the induced magnetic dipole obeys the right hand rule.

If the magnetic field is sufficiently strong, the two induced magnetic dipoles tend to line up with the field via the enantiomeric isomers reorienting. As a result of such reorienting, one enantiomer has the polar carboxyl group on top of its nuclear frame and the other the non-polar alkyl group on top, as shown in FIG. 1C.

The reoriented enantiomer pair flows into a LC column that is placed in the magnetic field and packed with a non-polar C18 stationary phase, as shown in FIG. 1D. At the first moment when the reoriented enantiomer meet and interact with the stationary phase, the enantiomer with the polar carboxyl group on top will try to avoid the C18 stationary phase and thus elute faster, whereas the enantiomer with the non-polar alkyl group on top will have more affinity toward C18 and likely be retained on the stationary phase and stay in the column for a longer time. This first moment interaction will strongly influence the overall retention time of the enantiomers, as they pass through the column, resulting in the two enantiomers being separated.

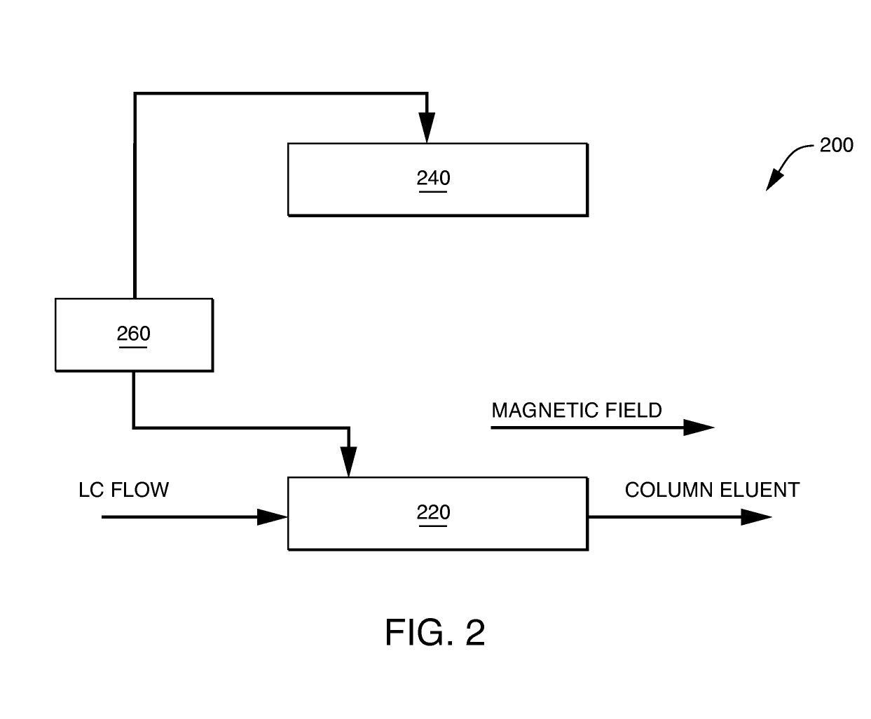

FIG. 2 is a schematic overview of a system 200 for separation of enantiomers. The system 200 includes a LC column 220, a magnetic field generator 240 and a control unit 260. The column 220 is packed with a stationary phase, through which a mobile phase carrying enantiomers flows. The magnetic field generator 240 generates a magnetic field, within which the column 220 is placed, to interact with the enantiomers, as the enantiomers elute through the column 220. The control unit 260, in communication with the magnetic field generator 240 and the LC column 220, adjusts the strength and direction of the magnetic field such that the two enantiomers are separated from each other.

The magnetic field generator 200 can be any suitable magnetic field generator, e.g., a solenoid, a permanent magnet, or a superconducting coil. In some implementations, the magnetic field applied to the column 220 is a static magnetic field.

In some implementations, the control unit 260 includes electrical circuitry operative to control the strength of the magnetic field. The strength of the magnetic field can be increased by the control unit 260 strong enough to induce a magnetic dipole in each of the enantiomers, to align the induced magnetic dipole with the magnetic field, and to amplify the differences between the respective interactions of the two enantiomers with the stationary phase, having the enantiomers to be separated as they pass through the column.

In some implementations, the control unit 260 controls the direction of the magnetic field, e.g., via a xyz translation stage coupled to the column 220. The direction, as used herein, refers to a spatial relationship or a relative position between a reference point of the magnetic field and the column 220, e.g., an angle between the direction of the field and the column 220, or a distance from a strongest point of the magnetic field to the center of the column 220. Such directions can be adjusted to enhance the interaction of the magnetic field with the enantiomers and thus enhance the differences between the respective interactions of the enantiomers with the stationary phase so that the enantiomers can be separated.

The column 220 can be any liquid chromatography column, such as a C18, C8, C4, monolithic, ion exchange, hydrophilic, or hydrophobic column. Depending on sample types, C18 columns can be a good option, because they are pH stable under either isocratic or gradient conditions. To avoid undesired interactions between the column 220 and the magnetic field, the column 220 can be encased in a non-magnetic material, e.g., a polymer or stainless steel, which is not magnetically attractive, nor does which screen off the magnetic field.

The control unit 260 includes a computing system. Examples of well known computing systems include, but are not limited to, embedded processors, personal computers, server computers, hand-held or laptop devices, multiprocessors, microprocessor-based systems, programmable consumer electronics, minicomputers, mainframe computers and the like.

In some implementations, the magnetic field strength “felt” by the column 220 can be largely enhanced by packing a ferromagnetic material, e.g., Fe₂O₄ nanocrystals, into the stationary phase of the column 220. The ferromagnetic material can exhibit superparamagnetic behavior and increase the local magnetic field strength at the column 220. Usually, the smaller the size the ferromagnetic material is, the greater the local magnetic field strength.

In some implementations, the differences between the respective interactions of the two enantiomers with a stationary phase can be augmented by addition of a chiral selector to either the stationary phase or the mobile or both. Such chiral selectors are not necessarily analyte-specific and can be very generic, so long as they possess chirality. Examples of such chiral selectors include cyclodextrins or cyclodextrin derivatives.

Chiral separation usually does not heavily rely on a mobile phase, as the separation is mainly through interaction between chiral molecules and functional groups bonded on the surface of a stationary phase. Therefore, any commonly used LC solvent, such as acetonitrile, methanol, water, etc., can be used as a mobile phase for the separation. Various buffers can also be applied to control the pH conditions of a mobile phase and/or a sample solution. The pH values can affect the retention of ionic or chiral compounds. An exemplary mobile phase buffer is phosphate buffer solution (PBS). A wide range of pH conditions can be tested for best separation results.

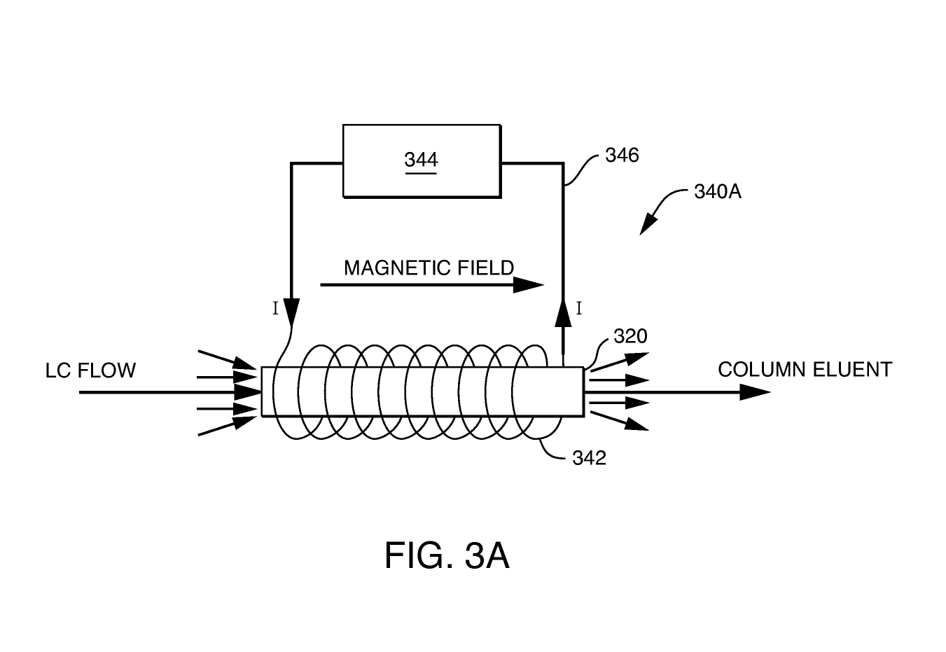

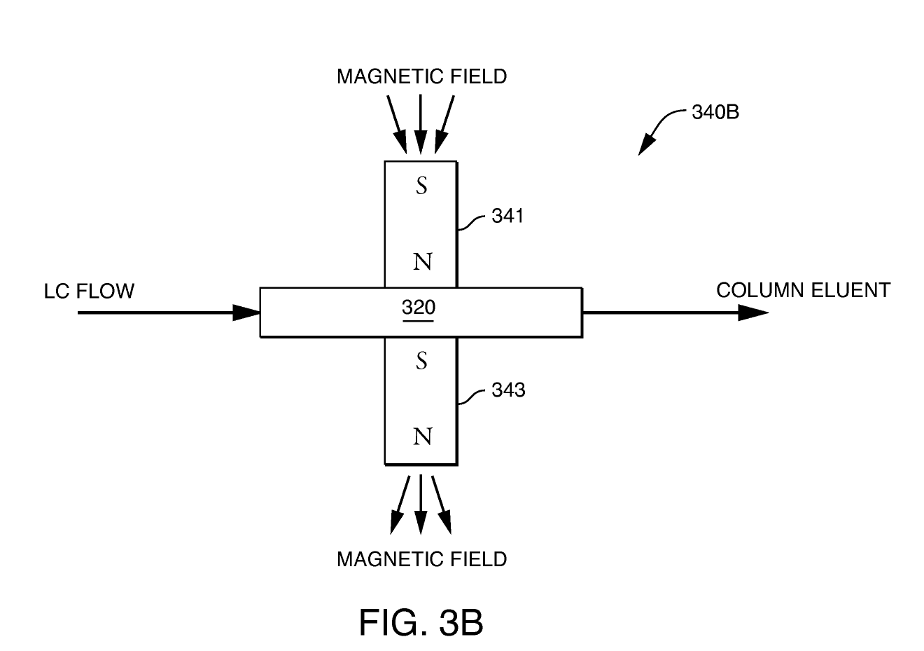

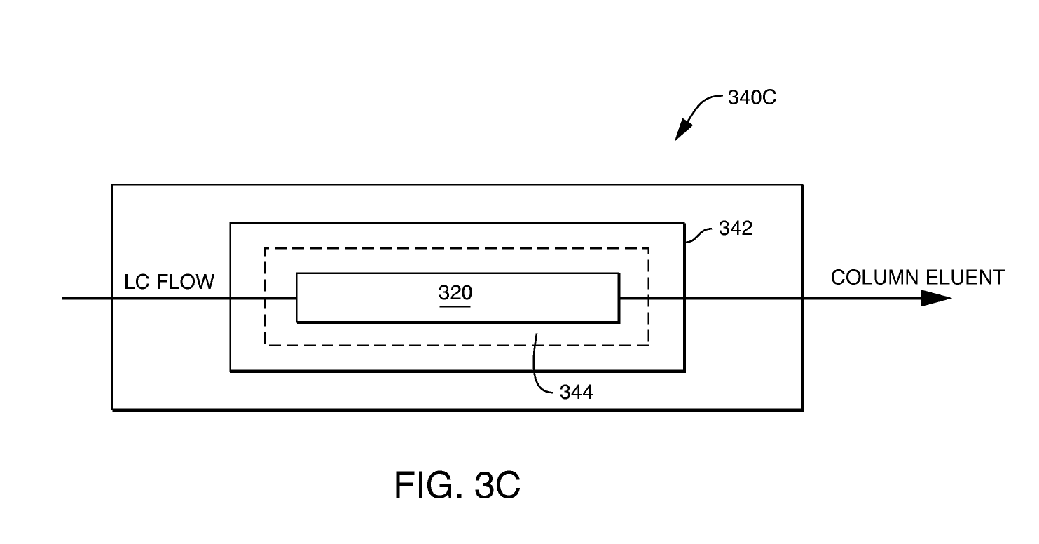

Turning now to FIGS. 3A-3C, three types of magnetic field generators are shown.

FIG. 3A depicts a solenoid magnetic field generator 340A, which includes a conductive wire coil or solenoid 342, encased in a non-conducting material, and a power supply 344, having circuitry 346 connected to the solenoid 342 for supplying current I thereto. The magnetic field generator 340A generates a magnetic field, having a magnetic flux distribution with its highest density inside the solenoid 342, within which a LC column 320 is disposed. In some implementations, the strength of the magnetic filed can be adjusted by varying the turns of the conductive wire coil 342 or/and by varying the magnitude of the current I provided by the power supply 344. The direction of the magnetic field can be fixed parallel to the column 320, as shown in FIG. 3A, or can be adjusted by positioning the column 320 differently inside the solenoid 342, e.g., to form an angle between the direction of the magnetic field and the column 320, or to vary the position of the column 320 relative to the center of the solenoid 342.

FIG. 3B illustrates a permanent magnetic field generator 340B, which includes two bar magnets 341, 343, each having a north pole N and a south pole S. The bar magnets 341, 343 are disposed on opposite sides of a LC column 320. The magnetic field lines of force flow from the south pole S to the north pole N through the bar magnets 341, 343, and flow from the north pole N to the south pole S through the air around the bar magnets 341, 343. The field strength of a bar magnet depends on many factors, including the material, size and weight of the bar magnet. These factors are fixed for the given bar magnets 341, 343, as in the case of FIG. 3B, the field strength experienced by the column 320 can be adjusted by varying angles and distances between the bar magnets 341, 343 and the column 320, e.g., increasing the vertical distance between the bar magnets 341, 343 and the column 320.

FIG. 3C shows a magnetic field generator 340C that includes a superconducting magnet or coil 342 having a homogeneous field zone 344 around the center of the coil 342. A LC column 320 is enclosed in the coil 342, in the homogeneous field zone 344, through which a mobile phase carrying enantiomers passes. The magnetic field generator 340C can generate a strong magnetic field of, e.g., up to about 10 Tesla or higher.

A strong magnetic field can produce a lot of heat, which, in turn, can produce a high degree of random motions of the induced magnetic dipoles, thus destroying the effectiveness of the chiral separation. To avoid this to happen, the system of FIG. 2 can include a temperature regulator (not shown) to regulate the temperature of the column 220. The temperature regulator can include one or more cooling elements and temperature sensors and be controlled by the control unit 260. The temperature sensors sense a rise in the column temperature and send temperature signals to the control unit 260. The control unit 260, in signal communication with the temperature sensors, coordinates the cooling elements to cool down the column 220, in response to the temperature signals.

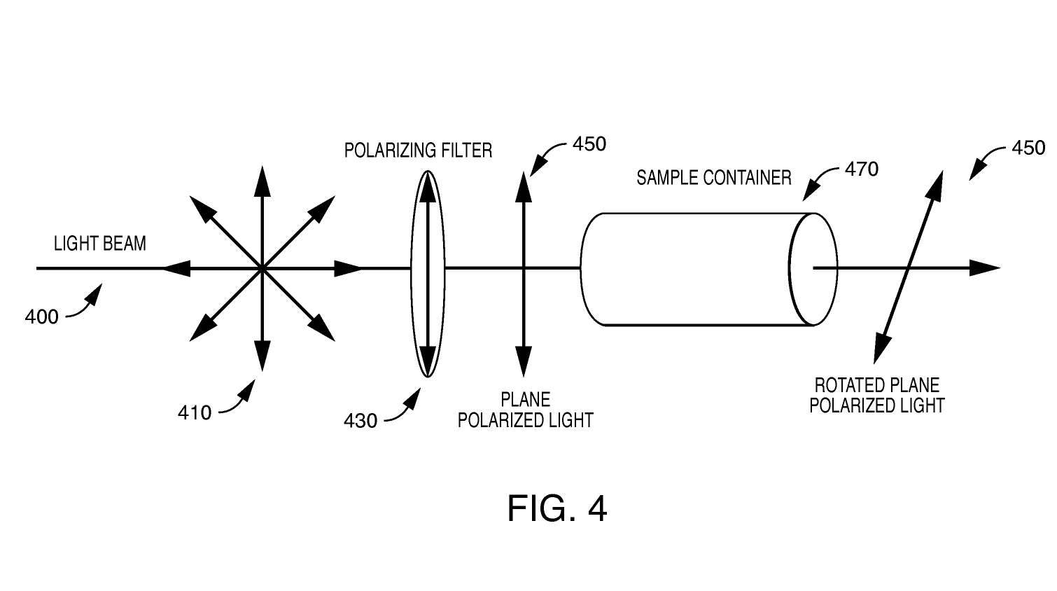

Alternatively, plane-polarized light can be employed to separate enantiomers, based on the optical activity of the enantiomers in respect of plane-polarized light. As presented above, as known in the art, both enantiomers rotate plane-polarized light; the right-handed (D-) enantiomer rotates the light clockwise, whereas the left-handed (L-) enantiomer rotates the light counterclockwise. FIG. 4 is a diagram illustrating this well known physical phenomenon.

As shown in FIG. 4, an unpolarized or a natural light beam 400 propagates toward a sample container 470 containing a solution of single (either D- or L-) enantiomers. The unpolarized light beam 400 is composed of electromagnetic waves 410 that vibrate in all directions perpendicular to the direction in which the light beam 400 travels. The unpolarized light beam 400 passes through a polarizer 430 and is transformed into a plane-polarized light beam 450, which is composed of only electric waves oscillating in one direction and magnetic waves oscillating perpendicularly to the electric waves. The plane-polarized light beam 450 passes through the sample container 470 containing single enantiomers and emerges rotated.

Employing plane-polarized light to separate enantiomers is based on the same idea: instead of letting enantiomers rotate plane-polarized light, letting plane-polarized light rotate enantiomers, and when this happens, the two enantiomers become two distinguishable species with respect to a separation medium filled in a column or a sample cell, thus being separated from each other.

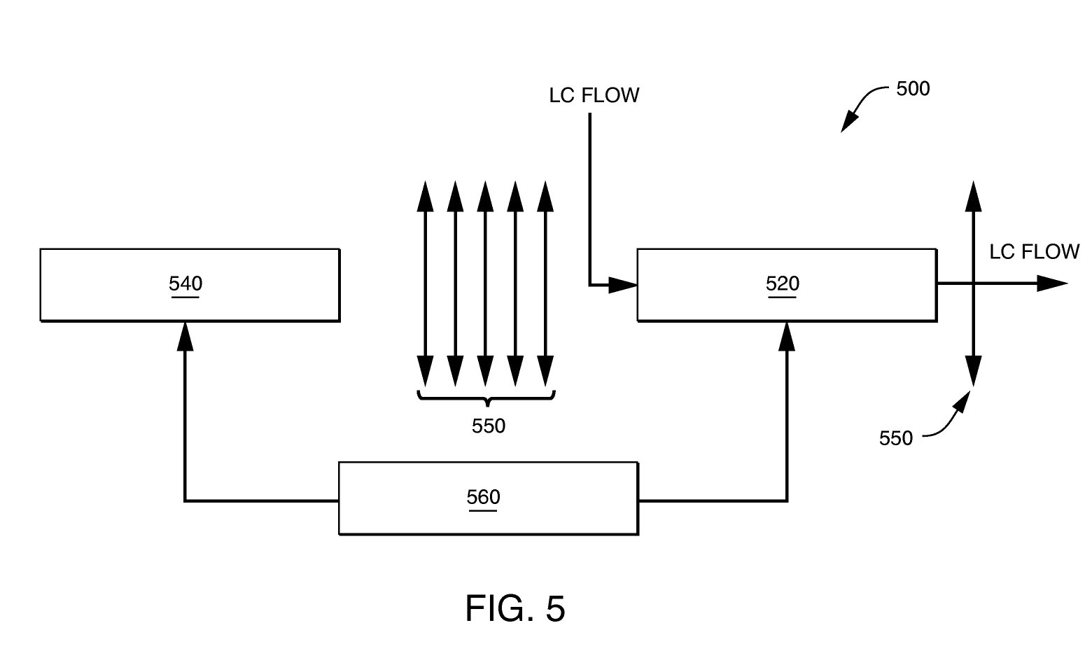

FIG. 5 illustrates a system 500 which includes a sample cell 520, a light source 540 and a control unit 560. The sample cell 520 is packed with a separation medium, through which a mobile phase carrying enantiomers passes. The light sources 540 produces a plane-polarized light beam 550, composed of only electromagnetic waves oscillating in a plane at a time, where the electric and magnetic waves (or electric and magnetic field components) are orthogonal to each other. The plane-polarized light beam 550 is directed to the sample cell 520 to interact with the enantiomers passing therethrough. The control unit 560, in communication with the light source 540 and the column 520, adjusts the intensity and direction of the plane-polarized light beam 550 such that enantiomers are separated from each other.

In some implementations, the light source 540 can be an unpolarized or a natural light source coupled with a specific polarizer, through which only electromagnetic waves oscillating in one particular plane pass through, while electromagnetic waves oscillating in other directions/planes are absorbed and disappear.

Alternatively, the light source 540 can be a coherent laser source that produces a pulsed or continuous-wave laser beam, the former can offer short and strong interaction with enantiomeric molecules and the latter steady interaction with the molecules.

The control unit 560 has electrical circuitry operative to control the intensity and direction of the plane-polarized light beam. In some implementations, the intensity of the plane-polarized light beam 550 can be increased by the control unit 360 to induce a magnetic dipole in each of the enantiomers and to align the induced magnetic dipole with the magnetic field component of the plane-polarized light beam 550. In other implementations, the light source can include light intensity control circuitry that can adjust the intensity of plane-polarized light. The intensity of plane-polarized light can also be adjusted by varying the photon density of the light or by increasing the number of the light beams.

The sample cell 520 of FIG. 5 can be a flow cell assembly made of a transparent material and contain a separation medium mixed with transparent beads. The separation medium and the transparent beads are preferably to be optically inactive over a working wavelength range of the light source 540, which is, preferably, in the range of infrared and visible wavelengths, since UV wavelengths can induce electronic transitions and thus affect bond formation of the separation medium. The system 500 can further include a plurality of optical elements, such as lenses, mirrors, etc.

Variations, modifications, and other implementations of what is described herein will occur to those of ordinary skill in the art without departing from the scope of the invention as claimed. Accordingly, the invention is to be defined not by the preceding illustrative description but instead by the scope of the following claims.

What is claimed is:

1. A system for separation of enantiomers, comprising:
a column packed with a stationary phase;
a magnetic field generator to generate a magnetic field, within which the column is placed, and the magnetic field interacting with the enantiomers as the enantiomers elute through the column with a mobile phase; and
a control unit in communication with the magnetic field generator and the column to adjust the strength and direction of the magnetic field to separate the enantiomers.

2. The system of claim 1, wherein the magnetic field generator comprises at least one solenoid, at least one permanent magnet, a superconducting magnet, or any other suitable magnetic field generator.

3. The system of claim 1, wherein the magnetic field is a static magnetic field.

4. The system of claim 1, wherein the strength of the magnetic field is adjusted to induce a magnetic dipole in each of the enantiomers and to align the induced magnetic dipole with the magnetic field.

5. The system of claim 1, wherein the direction of the magnetic field is adjusted by varying an angle or a distance, or both thereof, between the magnetic filed and the column.

6. The system of claim 1, wherein the stationary phase comprises a ferromagnetic material.

7. The system of claim 6, wherein the ferromagnetic material comprises Fe₃O₄ nanocrystals having a size of smaller than 1000 nm.

8. The system of claim 1, wherein the column is a C18, monolithic, ion exchange, hydrophilic, hydrophobic, or any other suitable liquid chromatography column.

9. The system of claim 1, wherein the column is encased in a non-magnetic material.

10. The system of claim 9, wherein the non-magnetic material comprises polyetheretherketone or stainless steel.

11. The system of claim 1, wherein one or both of the mobile phase and stationary phase comprise a chiral selector.

12. The system of claim 11, wherein the chiral selector comprises cyclodextrins or cyclodextrin derivatives.

13. The system of claim 1 further comprising a temperature regulator comprising one or more temperature sensors and one or more cooling elements to regulate the temperature of the column.

14. The system of claim 13, wherein the one or more temperature sensors are operatively coupled to the column to sense a rise in the temperature thereof and send one or more temperature signals to the control unit.

15. The system of claim 14, wherein the control unit, in signal communication with the one or more temperature sensors, controls the operation of the one or more cooling elements, in response to the one or more temperature signals.

16. A system for separation of enantiomers, comprising:
a column packed with a stationary phase;
at least one light source to produce at least one plane-polarized light beam, and the at least one plane-polarized light beam directed to the column to interact with the enantiomers as the enantiomers elute through the column with a mobile phase; and
a control unit in communication with the light source and the column to adjust the intensity and direction of the at least one plane-polarized light beam to separate the enantiomers.

17. The system of claim 16, wherein the at least one light source comprises a natural light source coupled with a polarizer.

18. The system of claim 16, wherein the at least one light source comprises a laser source.

19. The system of claim 18, wherein the laser source comprises a pulsed laser source or a continuous-wave laser source.

20. The system of claim 16, wherein the intensity of the at least one plane-polarized light beam is adjusted to induce a magnetic dipole in each of the enantiomers and to align the induced magnetic dipole with the magnetic field component of the at least one plane-polarized light beam.

21. The system of claim 16, wherein the light source comprises light intensity control circuitry to control the intensity of the at least one plane-polarized light beam.

22. The system of claim 16, wherein the intensity of the at least one plane-polarized light beam is adjusted by varying the photon density of the at least one plane-polarized light beam.

23. The system of claim 16, wherein the intensity of the at least one plane-polarized light beam is adjusted by varying the number of the at least one plane-polarized light beam.

24. The system of claim 16, wherein the column and the stationary phase comprise a transparent material.

25. The system of claim 24, wherein the transparent material is optically inactive over a working wavelength range of the at least one light source.

26. The system of claim 25, wherein the working wavelength range is from infrared wavelengths to visible wavelengths.
